(19) United States
(12) Patent Application Publication
(10) Pub. No.: US 2023/0417269 A1
(43) Pub. Date: Dec. 28, 2023

(54) Quarter Turn Fastener

(71) Applicant: Illinois Tool Works Inc., Glenview, IL (US)

(72) Inventor: Jeffrey J. Steltz, Chippewa Falls, WI (US)

(21) Appl. No.: 18/212,527

(22) Filed: Jun. 21, 2023

Related U.S. Application Data
(60) Provisional application No. 63/356,054, filed on Jun. 28, 2022.

(51) Int. Cl. F16B 21/09; F16B 21/08; F16B 21/07

(52) U.S. Cl. CPC F16B 21/09; F16B 21/082; F16B 21/076

(57) ABSTRACT

Described is a two-piece fastener assembly having a pin and a grommet. The pin can be installed with a straight push to engage box prongs with slots contained in the grommet. To remove the pin, the pin can be rotated (e.g., 90 degrees) to depress the box prongs. The box prongs include a chamfer or round on the side edge of the box prong to facilitate rotation and depression. Once the box prongs are depressed, the pin will is free for removal.

### CROSS-REFERENCE

The present application claims priority to U.S. Provisional Patent Application No. 63/356,054, filed Jun. 28, 2022, and entitled “Quarter Turn Fastener” which is hereby incorporated by reference in its entirety.

### BACKGROUND

Automotive components require fastening techniques that are simple to manufacture and assemble. Further, fastening techniques should above all be reliable and efficient. One example fastening assembly is the pin and grommet fastener, which can be used in various applications.

Traditional pin and grommet fastener assemblies include two main components: a pin and a grommet. During it's installation, the pin is pushed into the grommet to engage one or more engagement features thereof, forming a secured connection therebetween. Removing the pin traditionally requires pulling the pin out of the grommet (e.g., in a direction opposite the insertion direction) until the one or more engagement features disengage, which can be difficult and/or damage one or both components (e.g., the one or more engagement features).

In view of the foregoing, a need exists for a fastening system with a pin that can be easily engaged and disengaged from the grommet while also allowing for a robust, secure attachment.

### SUMMARY

The present disclosure relates generally to a fastening assembly to form a connection between two components, such as automotive components and panels, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates a perspective assembly view of an example fastener assembly in accordance with aspects of this disclosure.

FIG. 1b illustrates a perspective assembled view of the example fastener assembly.

FIGS. 2a and 2b illustrate perspective and angled assembly views of the example fastener assembly.

FIGS. 2c through 2f illustrate, respectively, first, second, third, and fourth side assembly views of the example fastener assembly.

FIG. 3a illustrates a perspective view of the fastener system.

FIG. 3b illustrates a cross-sectional view of the fastener system taken along cutline A-A of FIG. 2a.

FIGS. 3c and 3d illustrate cross-sectional, side elevational views of the fastener system taken along, respectively, cutline A-A of FIG. 2a and cutline B-B of FIG. 2a.

FIGS. 3d and 3e illustrate, respectively, cross-sectional bottom plan and perspective views of the fastener system taken along cutline C-C of FIG. 2e.

FIG. 4a illustrates a pin in a secured position relative to a grommet.

FIG. 4b illustrates an intermediate position where the pin is rotated about an axis of rotation to disengage the grommet.

FIG. 4c illustrates an unsecured position where the pin is rotated to fully disengage the grommet.

FIG. 5 illustrates a side elevational view of the example multidirectional fastener assembly.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Disclosed is a two-piece fastener assembly having a pin and a grommet. The pin can be installed with a straight push to engage box prongs with slots contained in the grommet. To remove the pin, the pin can be rotated (e.g., 90 degrees) to depress the box prongs. The box prongs include a chamfered edge (or rounded edge) on a side edge of the box prong to facilitate rotation of the pin and depression of the box prong. Once the box prongs are sufficiently depressed to clear a slot of the grommet, the pin will is free for removal.

In one example, a fastener assembly configured to secure a first component having a first opening to a second component having a second opening comprises: a grommet configured to engage the second component via the second opening, the grommet comprising a cavity; and a pin configured to engage the cavity via a linear motion and to disengage from the cavity via a rotational motion.

In another example, a fastener assembly configured to secure a first component having a first opening to a second component having a second opening comprises: a grommet configured to engage the second component via the second opening, the grommet comprising a cavity; and a pin configured to engage the cavity, wherein the pin comprises a pin body portion and a head portion, wherein the pin body portion comprise a box prong resiliently coupled to a sidewall of the pin body portion, and wherein the box prong comprises a chamfered edge configured to interact with the grommet at or adjacent a slot in or on the grommet.

In yet another example, a pin for use with a grommet in a fastener assembly to secure a first component to a second component comprises: a head portion; and a pin body portion extending perpendicularly from the head portion, wherein the pin body portion comprise a box prong resiliently coupled to a sidewall of the pin body portion, and wherein the box prong comprises a chamfered edge configured to interact with the grommet at or adjacent a slot in or on the grommet.

In some examples, the pin comprises a pin body portion and a head portion. The pin body portion comprise a box prong resiliently coupled to a sidewall of the pin body portion and configured to engage the grommet via a slot formed therein. The box prong comprises a chamfered edge configured to interact with the grommet at or adjacent the slot. In some examples, at least two sides of the box prong comprises a chamfered edge configured to interact with the grommet at or adjacent the slot.

In some examples, during rotational motion, the chamfered edge is configured to engage an edge of the slot to disengage the pin from the cavity and/or an edge of the slot to urge the box prong inwardly.

In some examples, the grommet comprises at least one retention tab resiliently coupled to and extending outwardly from a sidewall of a grommet body portion of the grommet and configured to engage the second component.

In some examples, the head portion comprises an engagement feature formed in or on the head portion and configured to engage a tool, while the grommet comprises a lip portion. In some examples, the pin body portion is cylindrical or rectangular.

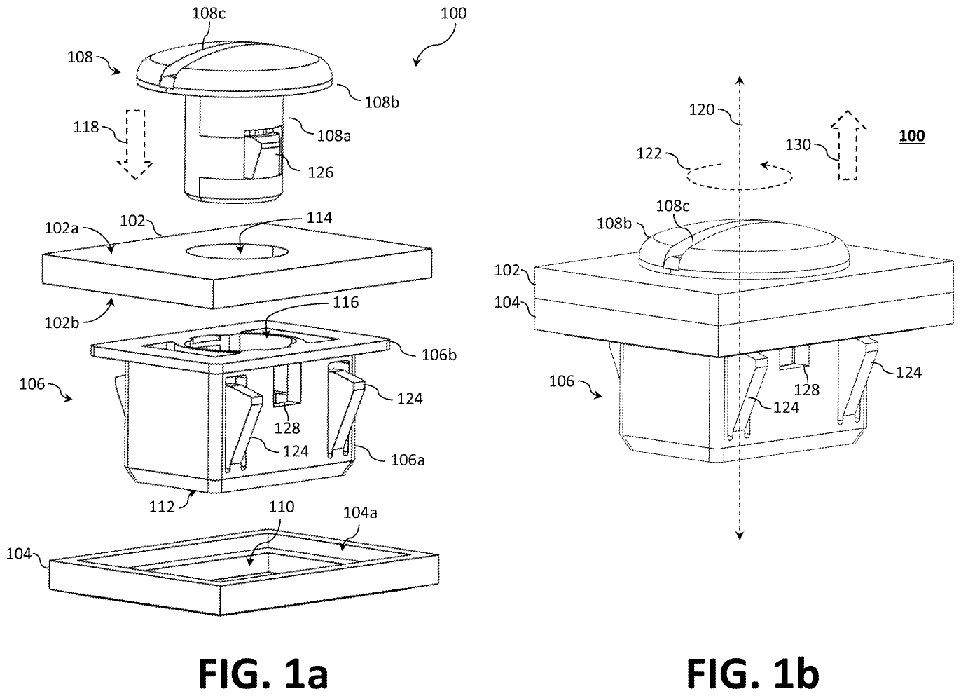

FIG. 1a illustrates a perspective assembly view of a fastening system having a fastener assembly 100 in accordance with aspects of this disclosure, while FIG. 1b illustrates a perspective assembled view of the example fastener assembly 100. As illustrated in FIGS. 1a and 1b, the fastener assembly 100 generally comprises a pin 108 and a grommet 106 to form a connection between a first component 102 and a second component 104.

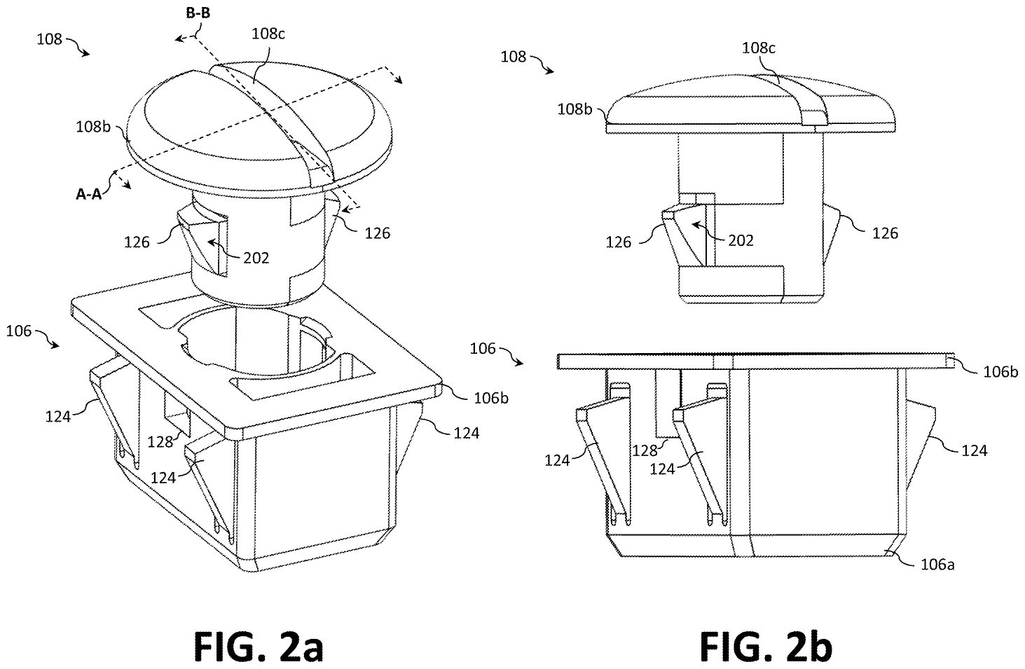

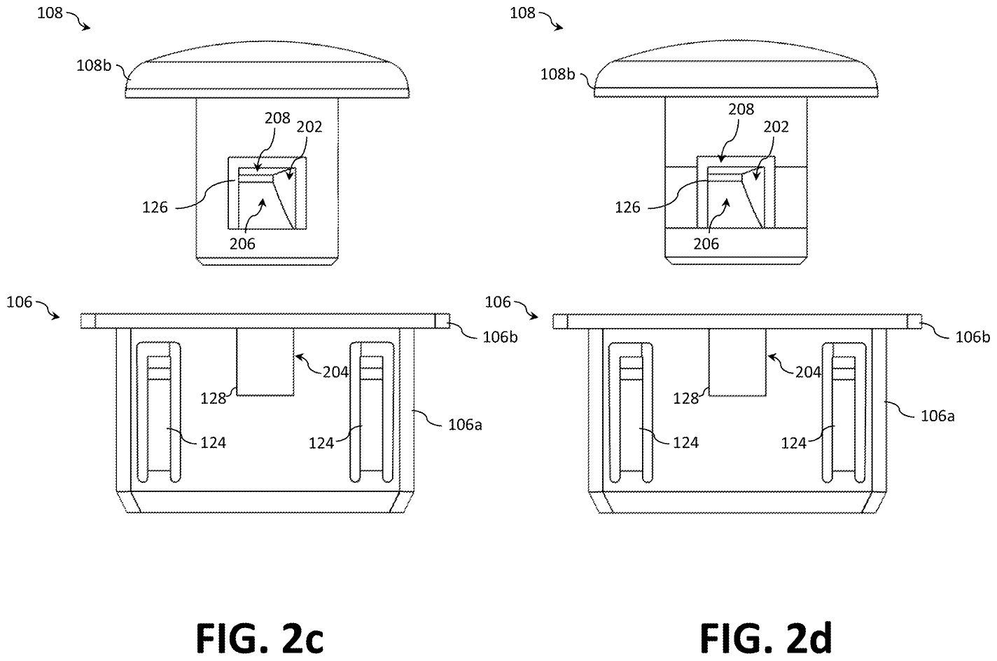

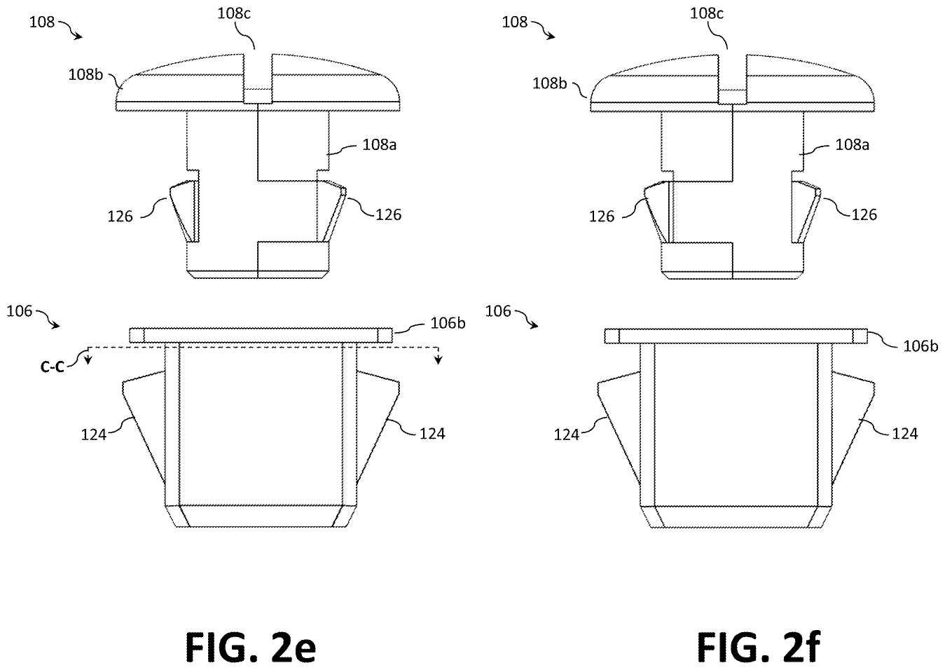

FIGS. 2a and 2b illustrate perspective and angled assembly views of the example fastener assembly 100. FIGS. 2c through 2f illustrate, respectively, first, second, third, and fourth side assembly views of the example fastener assembly 100. In each of the views of FIGS. 2a through 2f, the first component 102 and the second component 104 are omitted to better illustrate the features of the fastener assembly 100.

The pin 108 includes a pin body portion 108a (e.g., a barrel or shaft) and a head portion 108b (e.g., a cap). The pin body portion 108a projects or extends perpendicularly from the head portion 108b. The head portion 108b includes an engagement feature 108c formed therein or thereon. In the illustrated example, the engagement feature 108c is illustrated as a linear slot (e.g., to receive a flat screw driver), but other shapes and configurations are contemplated, such as a Phillips-style slot, square, star, a hex-shaped head portion, or the like.

The pin body portion 108a includes one or more box prongs 126 resiliently coupled to a sidewall of the pin body portion 108a and configured to engage the grommet 106 (e.g., via corresponding features, such as slots 128 formed therein). In the illustrated example, the pin body portion 108a is illustrated as generally cylindrical, though other shapes are contemplated. The pin 108 may be fabricated in various sizes depending on the application.

The grommet 106 includes a grommet body portion 106a having a cavity 116 formed therein and a lip portion 106b at the perimeter of the upper end of the grommet body portion 106a. The cavity 116 is sized and shaped to receive the pin body portion 108a of the pin 108 and engage the pin body portion 108a via one or more engagement features. In the illustrated example, the grommet body portion 106a comprises one or more slots 128 (e.g., rectangular slots or openings), each of the one or more slots 128 is configured to receive and retain a box prong 126 associated with the pin 108. In the illustrated example, the grommet body portion 106a is illustrated as generally rectangular (e.g., a rectangular prism), though other shapes are contemplated, including, for example, cylindrical shapes. The grommet 106 may be fabricated in various sizes depending on the application.

The first component 102 includes, defines, or otherwise provides a first opening 114, which is illustrated as a circular hole sized to receive the pin body portion 108a of the pin 108, while the second component 104 includes, defines, or otherwise provides a second opening 110, which is illustrated as a rectangular window sized to receive the grommet body portion 106a of the grommet 106. During assembly, it can be useful to assemble the first component 102 and the second component 104 by first inserting the grommet body portion 106a of the grommet 106 into the second opening 110 of the second component 104 to form a part in assembly (PIA), inserting the pin body portion 108a of the pin 108 through the first opening 114 of the first component 102 to form a part in assembly (PIA), and then subsequently inserting the pin body portion 108a of the pin into cavity 116 of the grommet 106 to form the assembly.

The pin 108 and the grommet 106 can be fabricated from a synthetic or semi-synthetic polymers (e.g., plastics, such as acrylonitrile butadiene styrene (ABS) and polyvinyl chloride (PVC), etc.), composite materials (e.g., fiber glass), or a combination thereof using a plastic injection technique, additive manufacturing, or otherwise. In some examples, the pin 108 and/or the grommet 106 may be fabricated using material extrusion (e.g., fused deposition modeling (FDM), stereolithography (SLA), selective laser sintering (SLS), material jetting, binder jetting, powder bed fusion, directed energy deposition, VAT photopolymerisation, and/or any other suitable type of additive manufacturing/3D printing process. In other examples, the pin 108 and the grommet 106 can be fabricated from a metal (or a metal alloy).

Depending on the application, the first component 102 and the second component 104 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof. In one example, the first component 102 is an automotive secondary panel and the second component 104 is an automotive primary panel. In the automotive industry, example first components 102 include, without limitation, jack covers, trailer hitch cover, door trim panels, moldings, trim pieces, and other substrates (whether use on the interior and exterior surfaces).

The first component 102 may define an A-surface 102a and a B-surface 102b (illustrated as an undersurface). The A-surface 102a, also called a class A surface, is typically the surface that is visible after assembly and, for that reason, is more aesthetically pleasing (e.g., include a logo, textured, coated, or otherwise decorated) and typically free of attachment devices and/or related features. Conversely, the B-surface 102b, also called a class B surface, is typically the surface that is not visible after assembly. The second component 104 may be, for example, a structural component of a vehicle, such as doors, pillars (e.g., an A-pillar, B-Pillar, C-Pillar, etc.), dashboard components (e.g., a cross member, bracket, frame, etc.), seat frames, center consoles, fenders, sills, sheet metal framework, or the like.

During assembly, e.g., to form the connection between the first component 102 and the second component 104, a leading end 112 of the grommet body portion 106a of the grommet 106 is first inserted into and through the second opening 110 formed in or on a surface of the second component 104 in the direction indicated by arrow 118. The grommet body portion 106a includes one or more retention tabs 124 resiliently coupled to and extending outwardly from a sidewall of the grommet body portion 106a. The one or more retention tabs 124 are configured to engage the second component 104 via the second opening 110 (e.g., via the perimeter). In the illustrated example, the grommet body portion 106a comprises four retention tabs 124 arranged with two retention tabs 124 positioned on opposite sides of the cavity 116. While four retention tabs 124 are illustrated, additional or fewer retention tabs 124 may be employed depending on the size of the grommet 106.

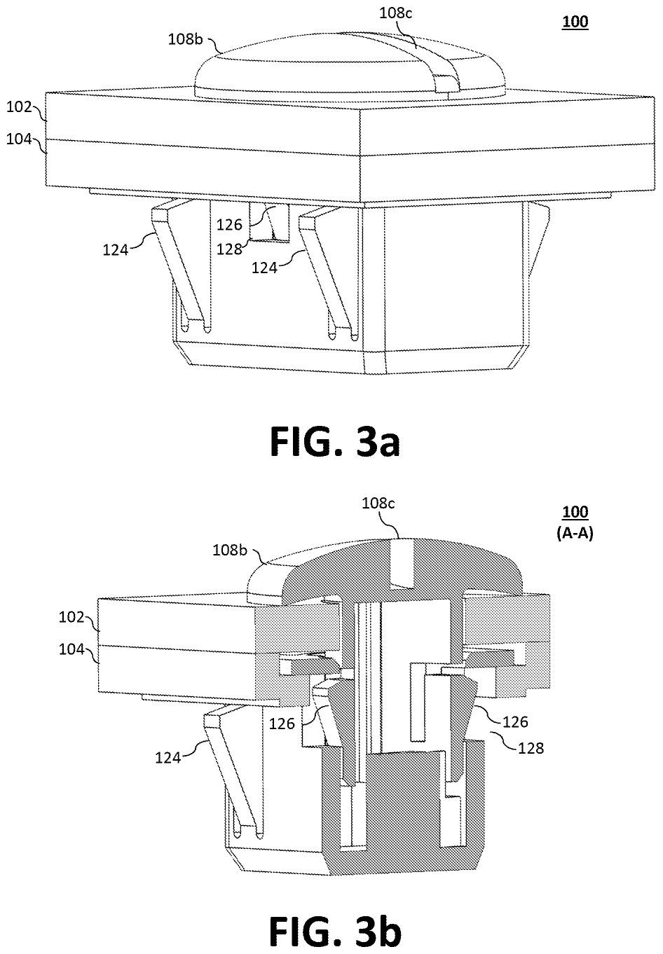

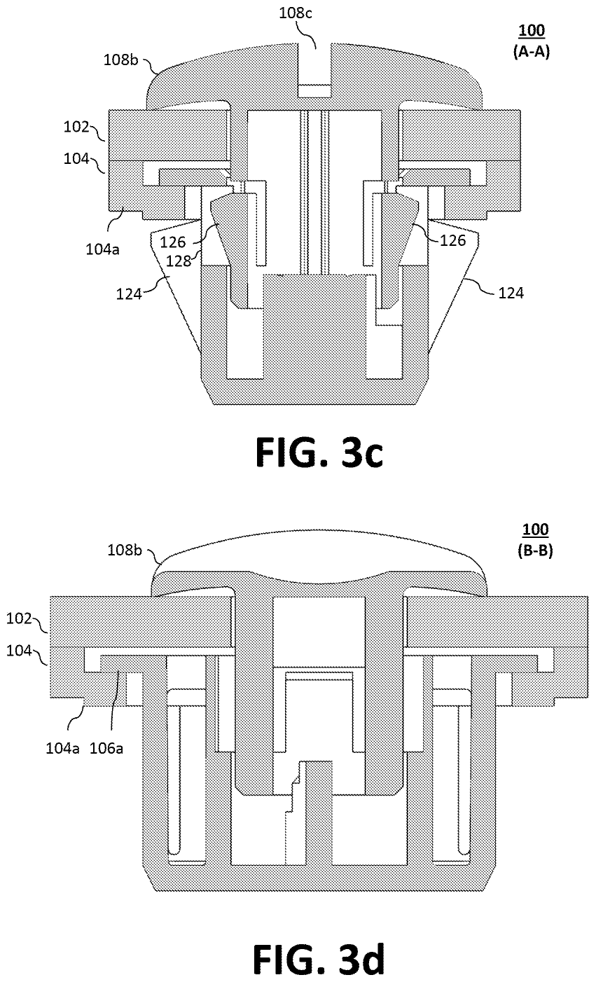

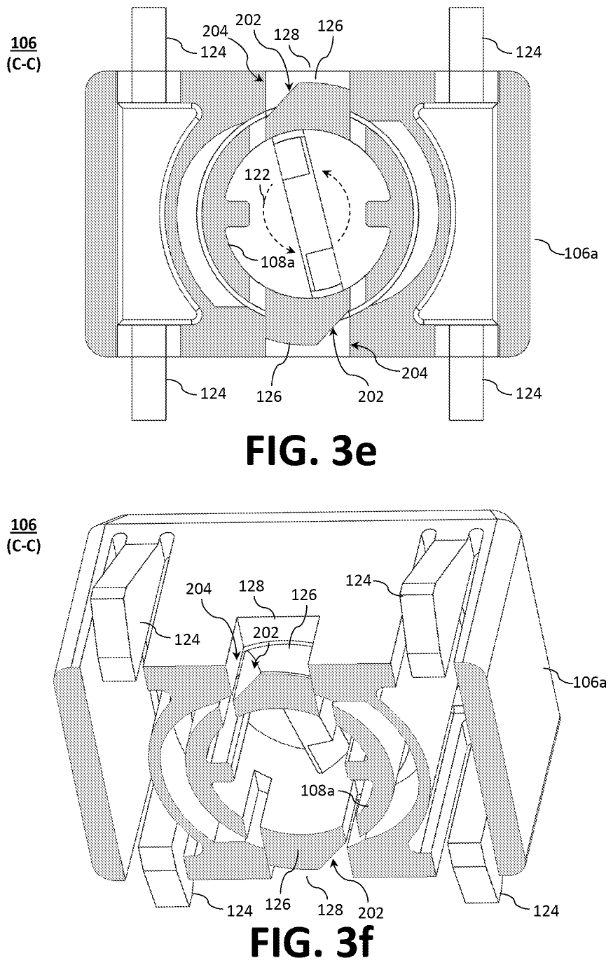

A retention tab 124 may be arranged on each side of the grommet body portion 106a, where desired. In the illustrated example, as best illustrated in the cross-sectional views of FIGS. 3a through 3d, the one or more retention tabs 124 are configured to retain (e.g., sandwiching the second component 104 between the one or more retention tabs 124 and underside of the lip portion 106b). In some examples, the grommet 106 can be inserted into the second opening 110 to define the part-in-assembly (PIA).

In the illustrated example, the second opening 110 is a generally rectangular window that corresponds to the size and shape of the grommet body portion 106a of the grommet 106. The second opening 110 can further comprise a recessed ledge 104a that is sized and shaped to receive and support the lip portion 106b of the grommet 106. The recessed ledge 104a allows for the top surface of the grommet 106 to be sub-flush, flush, or otherwise even with the surface of the second component 104, thus allowing the first component 102 and the second component 104 to be in intimate contact with one another as illustrated in FIG. 1b.

Once the grommet 106 is inserted into second opening 110, the pin body portion 108a of the pin 108 can be inserted into the cavity 116 formed in the grommet 106 via a linear motion (e.g., a straight push in the direction indicated by arrow 118) via the first opening 114. During this process, a tapered surface 206 at a leading end of the box prong 126 engages a bottom edge of the slots 128 to compress the box prong(s) 126 inwardly (toward the axis of rotation 120) until the box prong(s) 126 align with the slots 128, at which point the box prongs 126 are permitted to extend outwardly—away from the axis of rotation 120 (e.g., returning to a default position)—and at least partially into the slots 128. Once assembled, the pin 108 is securely held in place via the engagement between a ledge 208 of the box prongs 126 and an upper edge of the slots 128—creating a firm and stable connection. The shape of the leading surfaces (e.g., tapered surface 206) and flexible nature of the retention tabs 124 and the box prongs 126 permit a relatively low insertion force required to insert the grommet 106 into the second opening 110 and, then, the pin 108 into the cavity 116 of the grommet 106. In some example, the insertion force may be about two to five pounds.

Securing the pin 108 relative to the grommet 106 via the first opening 114 and second opening 110 likewise secures the first component 102 and the second component 104 relative to one another. When assembled (as illustrated in FIG. 1b), the second component 104 is covered at least partially by the first component 102.

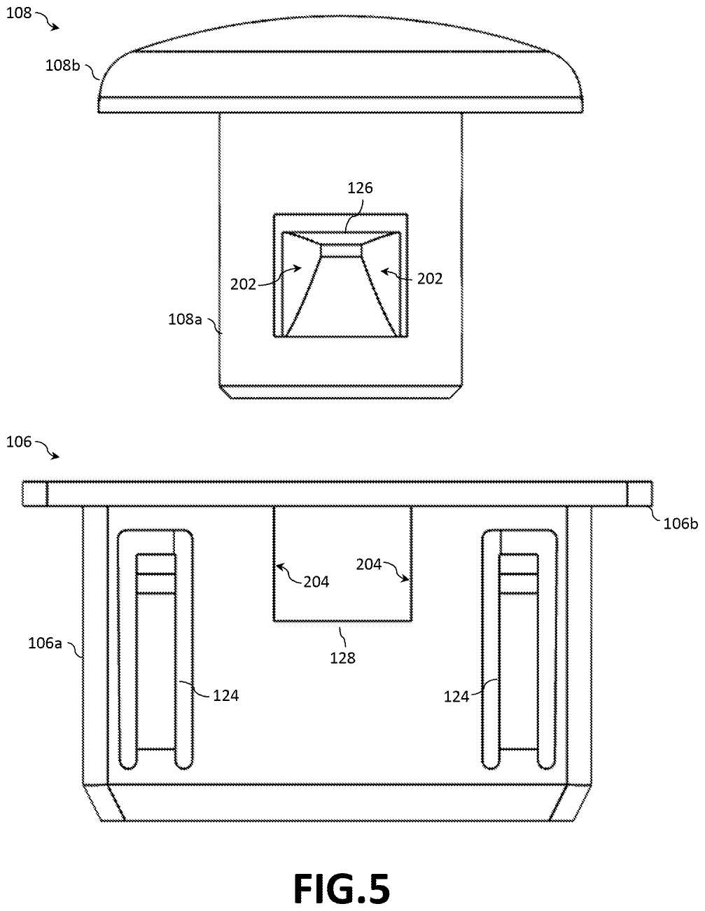

While the pin 108 is configured to engage the cavity 116 via a linear motion, the pin 108 is configured to disengage the cavity 116 via a rotational motion. For example, to remove the pin 108 form the grommet 106, the pin 108 can be rotated about an axis of rotation 120 in the direction indicated by arrow 122 (e.g., in 90-degree rotation, aka a quarter turn). While the direction indicated by the arrow 122 is counter-clockwise (when viewed form above), the pin 108 could alternatively be rotated in a clockwise direction to release the pin 108 or either a clockwise or a counter-clockwise direction (an example of which is illustrated and described in connection with FIG. 5).

To facilitate rotation, the pin 108 can be engaged using a tool, such as a screw driver, via the engagement feature 108c formed in or on the head portion 108b. When the pin 108 is rotated, the box prongs 126 are compressed to thereby disengage from the respective slots 128, allowing the pin 108 to be easily removed and then pulled out of the cavity 116 in the direction indicated by arrow 130. In another example, the head portion 108b of the pin 108 can be manually manipulated by hand. In such an example, the head portion 108b can be larger and/or textured to increase a user's grip. While a 90-degree rotation is primarily described, other degrees or rotation may be used depending on, for example, the size and number of box prongs 126, which affects the spacing and rotational requirement to disengage. For example, where four box prongs 126 are employed and spaced 90 degrees about the pin body portion 108a, a 45-degree rotation can be employed to disengage the pin 108 (thereby positioning and compressing the box prongs 126 between slots 128).

FIG. 3a illustrates a perspective view of the fastener system 100, while FIG. 3b illustrates a cross-sectional view thereof taken along cutline A-A of FIG. 2a. FIGS. 3c and 3d illustrate cross-sectional, side elevational views of the fastener system 100 taken along, respectively, cutline A-A of FIG. 2a and cutline B-B of FIG. 2a. FIGS. 3d and 3e illustrate, respectively, cross-sectional bottom plan and perspective views of the fastener system 100 taken along cutline C-C of FIG. 2e.

As best illustrated in FIGS. 3b through 3d, when assembled, the box prongs 126 pass through to engage the respective slots 128. The first component 102 and second component 104 are sandwiched between an underside surface of the head portion 108b and an upper edge of the retention tabs 124.

Turning to FIGS. 3e and 3f, each of the box prongs 126 includes a chamfered edge 202 or round on one or more side edges of the box prong 126. The chamfered edge 202 is provided as a beveled or angled edge. For example, the chamfered edge 202 is illustrated a small, sloping cut or bevel along the edge of the box prong 126, creating a flat surface at an angle instead of a sharp 90-degree corner. By incorporating a chamfered edge 202 on a box prong 126, the otherwise sharp edge is replaced with a beveled surface. The specific dimensions and angle of the chamfered edge 202 on a box prong 126 can vary depending on the design requirements and application. For instance, the chamfered edges 202 are shaped such that the pin 108 can be rotated about an axis of rotation 120 in the direction indicated by arrow 122 (e.g., in 90-degree rotation, aka a quarter turn), the chamfered edges 202 abut the side edge 204 of the respective slots 128. Therefore, the box prong 126 comprises a chamfered edge 202 that is configured to interact with the grommet 106 at or adjacent the slot 128.

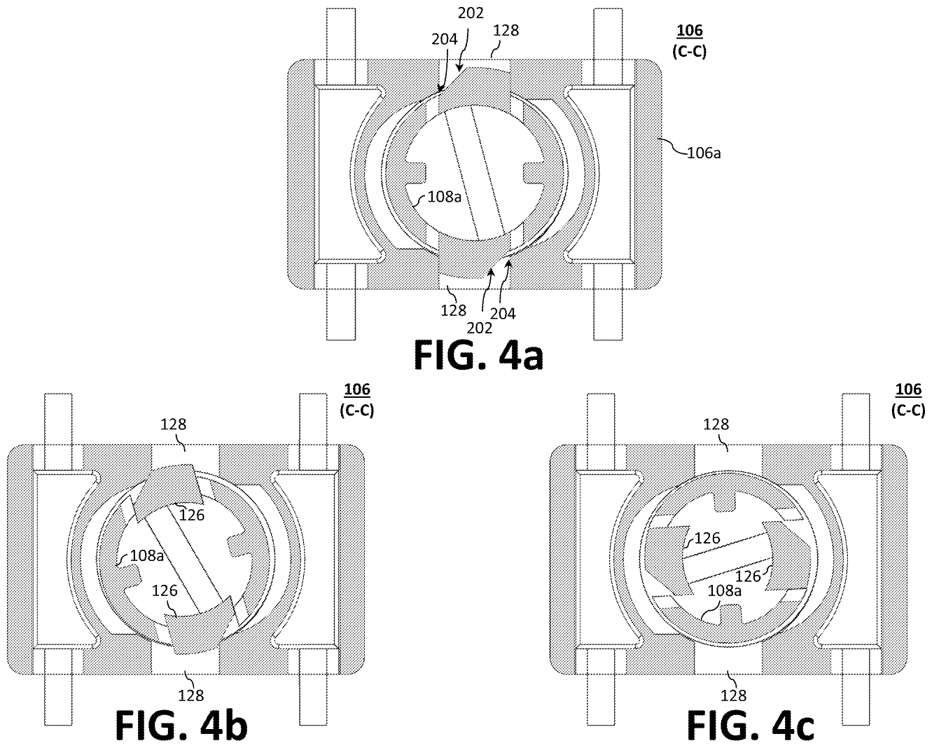

FIGS. 4a through 4c illustrate different stages of the removal process for the pin 108 from the grommet 106. FIG. 4a illustrates the pin 108 in a secured position where the box prongs 126 pass through to engage the respective slots 128. In this position, the pin 108 and the grommet 106 are secured to one another.

FIG. 4b illustrates an intermediate position where the pin 108 is rotated about an axis of rotation 120 in the direction indicated by arrow 122 to begin disengaging the box prongs 126 from the respective slots 128. As illustrated, when the pin 108 is rotated, the chamfered edge 202 contacts the side edge 204 of the respective slots 128, which then urges the box prongs 126 inwardly toward the axis of rotation 120.

FIG. 4c illustrates an unsecured position (i.e., a released position) where the pin 108 is rotated about an axis of rotation 120 in the direction indicated by arrow 122 by 90 degrees to fully disengage the box prongs 126 from the respective slots 128. As illustrated, when the pin 108 continues to rotate from the position illustrated in FIG. 4b, the chamfered edges 202 continue contact and slide along the side edge 204 of the respective slots 128 until the box prongs 126 are pushed inwardly toward the axis of rotation 120 to fully clear the side edge 204 of the respective slot 128.

While the prior examples have been unidirectional (i.e., where the pin 108 can only be rotated about an axis of rotation 120 in one direction—the direction indicated by arrow 122) to disengage the box prongs 126 from the respective slots 128, other configurations are contemplated. For example, the pin 108 could alternatively be rotated in a clockwise direction to release the pin 108 by positioning the chamfered edge 202 on the opposite side edge of the box prong 126. In another example, the pin 108 may be multidirectional and configured to disengage the box prongs 126 from the respective slots 128 when rotated in either a clockwise or a counter-clockwise direction. In this, example, a chamfered edge 202 can be positioned on each side edge of the box prong 126, an example of which is illustrated in FIG. 5. In this example, the pin 108 can be installed via a straight push in the direction indicated by arrow 118 as describe above, but then removed through rotation about the axis of rotation 120 in either a clockwise or a counter-clockwise direction. Therefore, the box prong 126 can comprise a chamfered edge 202 on at least two sides thereof that are configured to interact with the grommet 106 at or adjacent the slot 128 to provide, for example, a multidirectional release.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A fastener assembly configured to secure a first component having a first opening to a second component having a second opening, the fastener assembly comprising:
a grommet configured to engage the second component via the second opening, the grommet comprising a cavity; and
a pin configured to engage the cavity via a linear motion and to disengage from the cavity via a rotational motion.

2. The fastener assembly of claim 1, wherein the pin comprises a pin body portion and a head portion.

3. The fastener assembly of claim 2, wherein the pin body portion comprise a box prong resiliently coupled to a sidewall of the pin body portion and configured to engage the grommet via a slot formed therein.

4. The fastener assembly of claim 3, wherein the box prong comprises a chamfered edge configured to interact with the grommet at or adjacent the slot.

5. The fastener assembly of claim 4, wherein during rotational motion, the chamfered edge is configured to engage an edge of the slot to disengage the pin from the cavity.

6. The fastener assembly of claim 4, wherein during rotational motion, the chamfered edge is configured to engage an edge of the slot to urge the box prong inwardly.

7. The fastener assembly of claim 1, wherein the grommet comprises at least one retention tab resiliently coupled to and extending outwardly from a sidewall of a grommet body portion of the grommet and configured to engage the second component.

8. The fastener assembly of claim 2, wherein the head portion comprises an engagement feature formed in or on the head portion and configured to engage a tool.

9. The fastener assembly of claim 1, wherein the grommet comprises a lip portion.

10. The fastener assembly of claim 2, wherein the pin body portion is cylindrical.

11. The fastener assembly of claim 7, wherein the grommet body portion is rectangular.

12. The fastener assembly of claim 3, wherein at least two sides of the box prong comprises a chamfered edge configured to interact with the grommet at or adjacent the slot.

13. A fastener assembly configured to secure a first component having a first opening to a second component having a second opening, the fastener assembly comprising:
a grommet configured to engage the second component via the second opening, the grommet comprising a cavity; and
a pin configured to engage the cavity,
wherein the pin comprises a pin body portion and a head portion,
wherein the pin body portion comprise a box prong resiliently coupled to a sidewall of the pin body portion, and
wherein the box prong comprises a chamfered edge configured to interact with the grommet at or adjacent a slot in or on the grommet.

14. The fastener assembly of claim 13, wherein during rotational motion, the chamfered edge is configured to engage an edge of the slot to disengage the pin from the cavity.

15. The fastener assembly of claim 13, wherein during rotational motion, the chamfered edge is configured to engage an edge of the slot to urge the box prong inwardly.

16. The fastener assembly of claim 14, wherein the grommet comprises at least one retention tab resiliently coupled to and extending outwardly from a sidewall of a grommet body portion of the grommet and configured to engage the second component.

17. A pin for use with a grommet in a fastener assembly to secure a first component to a second component, the fastener assembly comprising:
a head portion; and
a pin body portion extending perpendicularly from the head portion,
wherein the pin body portion comprise a box prong resiliently coupled to a sidewall of the pin body portion, and
wherein the box prong comprises a chamfered edge configured to interact with the grommet at or adjacent a slot in or on the grommet.

18. The fastener assembly of claim 17, wherein during rotational motion, the chamfered edge is configured to engage an edge of the slot to disengage the pin from the grommet.

19. The fastener assembly of claim 17, wherein during rotational motion, the chamfered edge is configured to engage an edge of the slot to urge the box prong inwardly.

20. The fastener assembly of claim 17, wherein the head portion comprises an engagement feature formed in or on the head portion and configured to engage a tool.
